(19) United States
(12) Patent Application Publication
(10) Pub. No.: US 2008/0202479 A1
(43) Pub. Date: Aug. 28, 2008

(54) Multipurpose engine equipped with a canister

(76) Inventors: Chikaya Ito, Kanagawa-ken (JP); Kazuhiro Maki, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/987,244

(22) Filed: Nov. 28, 2007

(30) Foreign Application Priority Data
Feb. 27, 2007 (JP) 2007-047368

(51) Int. Cl. F02M 33/02

(52) U.S. Cl. 123/519

(57) ABSTRACT

The present invention relates to a multipurpose engine including a canister that adsorbs evaporated fuel generated in a fuel tank as well as desorbs a desorbs the fuel so that the fuel can be led to an air suction system of the engine. A multipurpose engine, comprising: a charge line leading an evaporated fuel generated in a fuel tank to a canister whereby the evaporated fuel is adsorbed; and a purge duct line that leads the evaporated fuel desorbed in the canister to an air suction system of the engine; wherein, the fuel tank is structurally sealed, has no vent to the atmosphere, is provide with a fuel supply opening compatible with a cap assembly of a sealed structure and is provided with a rollover valve on a surface of the fuel tank; wherein, the fuel supply opening and the cap assembly form no vent except when the engine is refueled; and further wherein, the charge line leading the evaporated fuel is gas-tightly connected to a discharge port of the rollover valve

### BACKGROUND OF THE INVENTION

1. Field of the Invention

The present invention relates to a multipurpose engine equipped with a canister adsorbing fuel vapor evaporated in a fuel tank, wherein the fuel vapor desorbed from the canister is introduced into an air suction system of the engine.

2. Description of the Related Art

As for a multipurpose engine either in stopped condition or under operation, a method for preventing a leakage of fuel vapor around the engine is disclosed by a patent literature 1 (JP: P2005-163690A) or 2 (JP: P2005-163688A).

Namely, the patent literature 1 discloses a method for preventing fuel vapor generated in a fuel tank from leaking outside an engine by steps comprising of providing a canister which adsorbs evaporated fuel generated in a fuel tank with a detachable tank-cap, providing a charge line which connects a fuel tank inside with the canister, making the attached tank-cap form a part of a charge line, and making the charge line go through inside the tank, while the patent literature 2 discloses a method for preventing fuel vapor generated in a fuel tank from leaking outside an engine, by means of placing a canister at a pertinent position so as to realize a compact size of an engine.

When the tank-cap is attached, the tank-cap not only shields the fuel tank from the ambient air but also forms the fuel vapor passage to the canister. Further, the tank-cap has a passage connected to the outside, and has a one-way valve thereon which opens when the inside pressure decreases below the ambient pressure so as to introduce the ambient air into the fuel tank through the passage connected to the outside. In this way, however, the construction of the conventional tank-cap is excessively intricate.

Not only for the fitting opening of the tank-cap, but also the fuel tank has to have a greatly complicated and artistic structure because a part of a charge line which leads the evaporated fuel of the fuel vapor passage to the canister goes through the inside of the fuel tank.

Regarding the placement of the canister, the patent literature 1 discloses that the canister is placed beside a crankcase of an engine as well as under a cylinder-block joined to a crankcase, wherein the cylinder-block has a cylinder axis, which is slanted upwards.

The patent literature 1 and 2 point out that it is an important feature that the charge line which leads the evaporated fuel from the fuel tank to the canister, and a purge duct line which leads desorbed vapor fuel from the canister to the air suction system are connected with one of the both side-surfaces of a canister casing i.e. a side facing the air suction side of the engine in order to evade heat attack on evaporated fuel.

In terms of conventional technology, one of the subjects to be solved is to simplify a structure of the fuel tank and the tank cap. Because a fuel replenishment frequency varies from an engine to an engine depending on the types and/or applied uses of work machines that are driven by a multipurpose engine, a different utilization of a multipurpose engine and a different environmental circumstance may bring greatly different open/close times of the tank cap. Thus, a tank unit and/or a tank cap of simple structure, robust design, and satisfactory high durability are desired in order to meet even a severe handling.

Conventionally, as shown in the patent literature 1, a fuel supply opening on the tank and the tank cap fitted thereby have to allow no leakage of fuel and fuel vapor to outside the tank. On the other hand, ambient air has to be introduce inside the tank so as to cancel out a negative pressure in the tank when the negative pressure arises in response to fuel consumption due to engine operation. Therefore the structure of the tank cap and the fuel tank is apt to be excessively complicated or artistic; as a result, great man-hours for production are required. From this reason, a further simplified and practical product has been more and more required.

The second subject to be solved is to develop a fuel tank unit comprising the fuel tank, the tank cap, and piping lines for which the maintenance and inspection of the unit must be easy or user-friendly. Actually, the fuel tank/cap system of the mentioned patent literature incorporates greatly complicated structure inside; consequently, visual inspection and/or field maintenance can not secure sound function of the system.

Moreover, the charge line for sending evaporated fuel to the canister runs down inside the fuel tank to the tank bottom, then goes through a narrow space on the top of the crankcase to the side of the cylinder-block, and reaches the canister. Because of this structure, providing enough visual inspection on each part of the charge line is difficult. This situation may also result in belated notice about cracks of the pipe, following fuel leakage or fuel vapor diffusion; moreover, the situation brings a fundamental problem that maintenance work is difficult.

As a conclusion, the charge line of evaporated fuel that goes through inside the fuel tank has to be changed into a duct line that runs outside the fuel tank.

The third subject to be solved relates to the efficiency of the canister and ventilation resistance in the canister. In the conventional technology as shown the patent literature 2, the cross section of the canister is reduced to a half of the former standard (a conventional cross section) and the length is doubled instead; a partition is provided inside the canister along the longitudinal direction so as to double, by coming and going, the ventilation length due to narrow fitting space.

This reason is derived from the technical feature that the charge line which leads evaporated fuel from the fuel tank to the canister, as well as the purge duct line which leads desorbed vapor fuel from the canister to the air suction system is connected to one of the both side-surfaces of the canister namely, a side-surface facing the air suction system.

The efficiency of the canister as to adsorbing evaporated fuel greatly depends on whether active carbon in the canister comes in contact with evaporated fuel smoothly or not. However, the cross section reduced into half as well as the doubled passage length deteriorates the adsorption efficiency. Furthermore, when air purges the adsorbed fuel, the ventilation resistance is obviously deteriorated. Thus, it is necessary to improve a design and a way to be used as to the canister.

### SUMMARY OF THE INVENTION

The present invention solves the above-mentioned subjects by following means.

First means is to realize a multipurpose engine equipped with a canister, which leads the evaporated fuel desorbed from the canister to an air suction system of the engine, comprises a charge line leading an evaporated fuel generated in a fuel tank to the canister whereby evaporated fuel is adsorbed to the charge line; wherein, the fuel tank is structurally sealed, has no vent to the atmosphere, is provide with a fuel supply opening compatible with a cap assembly of a sealed structure and is provided with a rollover valve on a surface of the fuel tank; wherein, the fuel supply opening and the cap assembly form no vent except when the engine is refueled; and the charge line leading the evaporated fuel is gas-tightly connected to a discharge port of the rollover valve.

Second means is to realize a multipurpose engine of the above-mentioned first means, wherein the charge line which runs downward along outside of the tank is gas-tightly connected to the canister which is annexed to the engine on the side of a head cover of a cylinder after the charge line is fixed by a clamp on a heat insulated side of a heat insulation plate.

Third means is to realize a multipurpose engine of the above-mentioned second means, wherein a purge duct line that leads the evaporated fuel desorbed in the canister to an air suction system of the engine runs on an exhaust gas manifold side of the engine; wherein a joint of the purge duct line is fitted on an end plate of the canister, and the plate is facing to the exhaust gas manifold side; a joint of an air suction line is fitted on an end plate of the canister, the plate facing to the air suction system side; and wherein through the joint, clean air via an air cleaner can be sent to the canister.

Fourth means is to realize a multipurpose engine of the above-mentioned third means, wherein clean air flows into the fuel tank through the air suction line, the canister, the charge line, and the rollover valve so as to cancel a negative pressure in case when a pressure inside the fuel tank drops below an ambient pressure.

### BRIEF DESCRIPTION OF THE DRAWINGS

FIG. 1 is a partially cutaway side view of a fuel tank according to an embodiment of the present invention, wherein the neighborhood of a tank cap and a fuel supply port is shown in a cross section.

FIG. 2 is a front view of a multipurpose engine, which can be compatible with a transpiration gas regulation, according to the present invention.

FIG. 3 is a side view of the engine seen from Z-arrow direction in FIG. 2.

FIG. 4 is a cross sectional view of the tank cap assembly wherein is not shown a connection strand for prevention of falling off.

### DETAILED DESCRIPTION OF THE PREFERRED EMBODIMENTS

Hereafter, aspects of the present invention will be explained by means of embodiments based on the attached figures. However, the dimensions, materials, shape, the relative placement and so on shall be only for explanation and shall not be construed as limiting the scope of the invention thereto, unless any specific mention is made of.

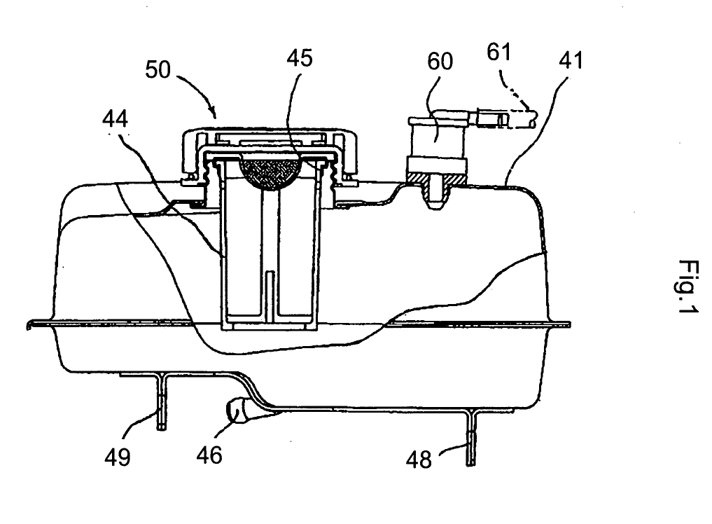

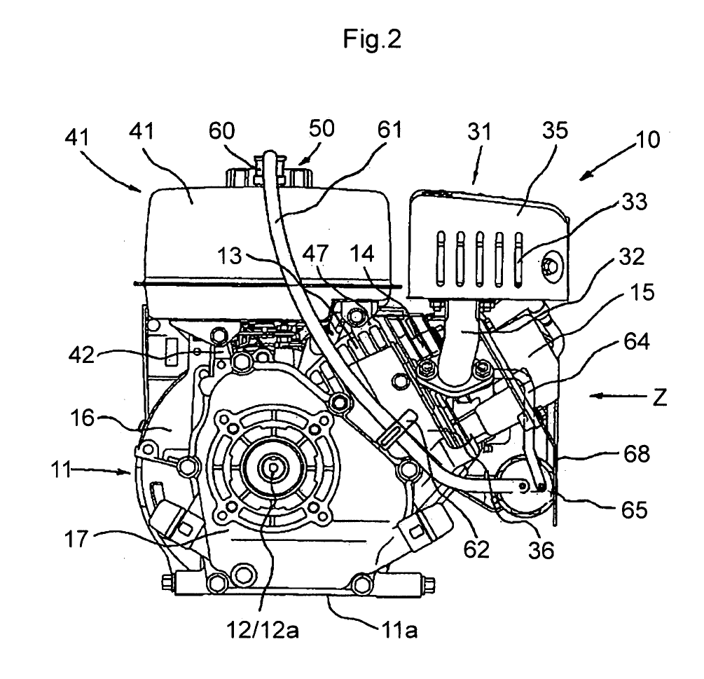

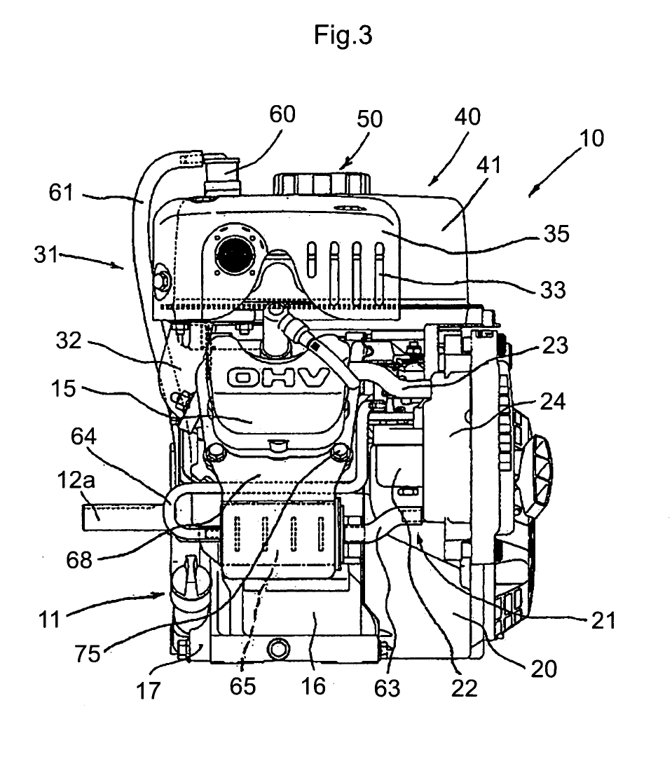

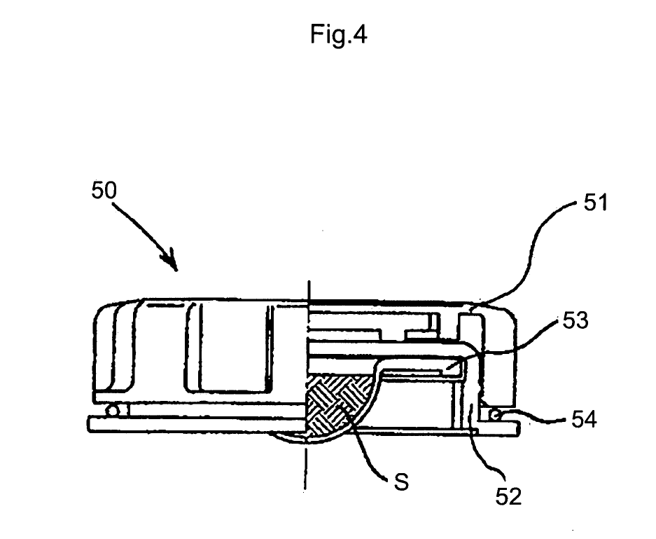

FIG. 1 is a partially cutaway side view of a fuel tank according to an embodiment of the present invention, wherein the neighborhood of a tank cap and a fuel supply port is shown in a cross section. FIG. 2 is a front view of a multipurpose engine, which can be compatible with a transpiration gas regulation, according to the present invention. FIG. 3 is a side view of the engine seen from Z-arrow direction in FIG. 2. FIG. 4 is a cross sectional view of the tank cap assembly, wherein is not shown a connection strand for falling-off prevention.

A multipurpose engine 10 in FIGS. 2 and 3 is an air-cooled single-cylinder engine used, for example, as a work machine. The engine comprises a crankcase 11, a cylinder-block 13 combined with a side face of the crankcase 11 wherein the center-line of the cylinder-block intersects the rotation axis of a crankshaft 12, and a cylinder head 14. On the outer surfaces of the cylinder-block 13 and the cylinder head 14, provided a number of fins for air-cooling.

An undersurface 11a of the crankcase 11 serves as a fixing surface. Usually, since a finished surface of an engine-bed of the driven work machine corresponds to the undersurface 11a in shape and dimensions, the engine is stably and tightly installed on the engine-bed. In addition, over an upper surface of the cylinder head 14, there are provided suction/exhaust valve gears (not shown), which are mantled with a head cover 15.

The crankcase 11 comprises a case body 16 and side covers 17; wherein the case body 16 forms a part of the cylinder-block 13 made by casting together with the case body 16; further, wherein the side covers 17 which blocks up both open ends of the case body 16 and the covers 17 includes main-bearings that rotatably support the crankshaft 12.

A protrusion 12a at an end of the crankshaft 12 protrudes from the side covers 17, and is connected to an input shaft of a work machine (not shown).

At the other end of the crankshaft 12, are connected a recoil starter (not shown) and a cooling fan (not shown) that are covered with a case 20 and are so protected from the outside.

An air suction system 21 is provided at a side of the case 20 that covers the recoil starter and so on, comprising: an intake-air manifold 23, a carburetor 22, and an air cleaner 24; wherein, the intake-air manifold 23 and the carburetor 22 are connected to the cylinder head 14 of the engine 10, while the air cleaner 24 is placed at an up-stream side of the carburetor 22.

A gas exhaust system 31 includes an exhaust gas manifold 32 and a muffler 33; wherein, the exhaust gas manifold 32 is placed at the other side of the carburetor 22 across the cylinder head 14 and is connected to the cylinder head 14, while the muffler 33 is connected to the exhaust gas manifold 32 and is mantled with a cover 35.

As the protrusion 12a connected to a work machine to be driven is placed at a side of the gas exhaust system 31 (see FIG. 3), it is necessary to protect the work machine from heat radiation released from the engine 10. Thus, to the protrusion 12a side of the cylinder-block 13, a heat insulation plate 36 is fixed to the engine 10 so as to support and fasten a charging line 61, which will be explained below, with a clip 62.

The air suction system 21 and the gas exhaust system 31 are properly allocated at the mutually opposite side across the cylinder-block 13 as well as across the cylinder head 14 located at an upper-side of the cylinder-block.

The engine 10 is provided with a fuel tank assembly 40 over the case body of the crankcase 11. A fuel tank assembly 40 includes a fuel tank 41 that is fixed to supporting arms 42 and 47; wherein the supporting arm 42 forms a part of the case body of the crankcase 11; namely, the arm 42 and the case body 16 belong to one body; and wherein the supporting arm 47 is annexed to the cylinder-block 13.

The fuel tank 41 (FIG. 1) looks like a comparatively large rectangular can of gas-tight seal, with corners rounded by somewhat large radii. So to speak, the tank has a structure as if the tank were made of a large lunch box of Japanese style so that the ridges of a rather deep dish-part and a lid-part are line-welded and the box is turned up side down.

On the upper surface of the fuel tank 41, is provided a fuel supply opening 45 the center axis of which lies in a vertical plane including the axis of the crankshaft 12. After a filter 44 is installed in and fixed to the opening 45, a cap assembly 50 is screwed into the opening 45; thus, the cap assembly 50 lids the tank, intercepting the tank air-tightly from the outside.

Somewhat apart from the fuel supply opening 45 on the upper surface of the fuel tank 41, is provided a rollover valve 60, namely, a valve of a type known well by a patent reference (JP, 4-46153,Y), for example. Vapor of evaporated fuel in the tank goes through the rollover valve 60 to a canister 65 at the downstream side, via the charge line 61; in addition, the rollover valve 60 can freely passes the ambient air that gets through the air-cleaner 24.

Further, even in case when the engine 10 and the fuel tank 41 are inclined and then the rollover valve 60 is filled with refluxed fuel, a float (not shown) inside the valve 60 closes non-return valve therein so as not to leak only a droplet of fuel toward the charge line 61.

At the lower surface side of the tank 41, are provided support brackets 48 and 49 that are stretched from the tank 41; wherein the support bracket 48 can be fixed to the supporting arm 42 that is extended from the case body 16, while the support bracket 49 can be fixed to the supporting arm 47 that is annexed to the cylinder-block 13.

Further, to the lower surface side of the tank 41, is attached a connection port 46 through which fuel is supplied to the carburetor 22 of the engine 10 via a fuel supply line (not shown).

While the engine 10 is under operation, fuel is constantly sent from the fuel tank assembly 40 to the carburetor 22; accordingly, the inside of the tank 41 holds a slight negative pressure; as a result, evaporated fuel does not leak outside.

When the engine is stopped, the fuel supply from the fuel tank assembly 40 to the carburetor 22 stops automatically; the pressure of evaporated fuel in the tank gradually increases and exceeds ambient pressure, causing potential risks of fuel leakage through clearances toward the periphery of the engine.

In the configuration of the fuel tank assembly 40 and the cap assembly 50 according to the present invention, there is no part that gives a clearance in the fuel supply opening 45. Therefore, evaporated fuel does not leak from the fuel tank assembly 40. And all the evaporated fuel flows into the canister 65 through the charge line 61 via a connection of the rollover valve 60 allocated near the cap assembly 50. In the canister 65, the evaporated fuel is adsorbed by adsorbent (for example, active carbon).

Thus, so far as the engine 10 is provided with the cap assembly 50 on the fuel tank 41, the evaporated fuel does not leak outside not to mention under operation, even in stop manipulation or in rest period.

The canister 65 of a cylindrical shape container is robustly designed and manufactured so that the canister is fastened to a canister bracket 68 by fixing members (not shown) such as bands, as if the canister is hugged thereby; wherein, the upper-part of the canister bracket 68 is fixed, with bolts 75, to the head cover 15 of the cylinder head 14. Thus, the canister 65 is satisfactorily protected from accidental impacts and local/transient pressure from the outside.

There is the limitation of the adsorption quantity as to the adsorbent filled up in a canister. Therefore, while the engine is operated, the canister 65 is refreshed by means of desorption and discharge of evaporated fuel, with an aid of generated negative-pressure in the air suction system 21.

By this reason, a connection of a purge duct line 64 for evaporated fuel is provided on an end face of the canister 65; wherein, the purge duct line 64 is led to the air suction system 21 of the engine 10; in addition, on end face of the canister 65, as well as the connection of a purge duct line 64, a connection of the aforementioned charge line 61 is placed in parallel to the former connection.

On the other hand, since clean air is needed for desorbing evaporated fuel from the adsorbent, an air suction line 63 is provided between another end face, that faces the air suction system 21, of the canister 65 and the air cleaner 24 of the system 21 so that cleaned air is induced to the canister 65; here, naturally, a connection for the line 63 is provided on the mentioned face.

Each process in the canister 65: inflow of evaporated fuel, adsorption thereof, desorption of adsorbed fuel by dry air, or purge function thereby, is characterized in gradualness and one-way flow. Thus, great efficiency as to adsorption/desorption of the adsorbent is obtained. Further, in comparison with conventional practices, larger cross-sectional area and shorter length of the adsorbent lesson passage resistance; smaller passage resistance also enhances the efficiency of the engine as to the recovery of evaporated fuel.

Moreover, even when a pressure inside the fuel tank 41 becomes a negative pressure for an unforeseen reason, cleaned air through the air cleaner 24 flows back into the tank 41 via the canister 65, the charge line 61, and the rollover valve 60, so that the negative pressure inside the fuel tank 41 can be readily canceled.

FIG. 4 shows a cap assembly 50 as an example of the present invention.

The cap assembly includes an outer cap 51 which a worker handles, an inner cap 52 which is screwed-in to the fuel supply opening 45 of the fuel tank 41, a packing 53 of convex hemisphere shape, in a center part of which a sponge S is attached, and a ring 54 which is placed between the outer cap 51 and the inner cap 52.

In the structure of this cap assembly 50, great importance is placed on a secure seal of the fuel supply opening 45. Therefore, the inner cap 52, which is screwed-in to the fuel supply opening 45, and the outer cap 51 are united with a ratchet mechanism such that, if a worker tightens the outer cap with an excessive torque over a limit value, the outer cap slips around the inner cap so as not to be over-tightened, while making a sound.

In addition, in FIG. 4, the packing 53 of convex hemisphere shape is provided with a sponge S in a center part of the hemisphere. The sponge itself is of porous packing used for conventional caps. The conventional packing, which is used so as to meet a current transpiration gas regulation, is not necessarily needed from a viewpoint of the present invention. An embodiment as to Claim 1 allows a fuel tank unit to be of a simple sealed type or of a partly modified conventional type. Thus, the present invention realizes a highly reliable fuel tank unit: tolerating an inclined disposition of a whole engine, being of simple manufacturing, and being of user-friendly system.

An embodiment of the present invention corresponding to Claim 2 makes compact an evaporated-fuel recovery unit and/or an evaporated-fuel adsorption unit; furthermore, easy maintenance and/or monitoring work can be realized.

Embodiments of the present invention corresponding to Claims 3 and 4 can provide a canister and/or a fuel tank unit therewith, which efficiently carries out adsorption and/or desorption of evaporated fuel as well as prevents evaporated fuel from diffusing around the engine, while simply introducing clean air and canceling a negative pressure if the pressure arises.

1. A multipurpose engine equipped with a canister, which leads the evaporated fuel desorbed from the canister to an air suction system of the engine, comprises a charge line leading an evaporated fuel generated in a fuel tank to the canister whereby evaporated fuel is adsorbed to the charge line;
wherein, the fuel tank is structurally sealed, has no vent to the atmosphere, is provide with a fuel supply opening compatible with a cap assembly of a sealed structure and is provided with a rollover valve on a surface of the fuel tank;
wherein, the fuel supply opening and the cap assembly form no vent except when the engine is refueled; and the charge line leading the evaporated fuel is gas-tightly connected to a discharge port of the rollover valve.

2. A multipurpose engine equipped with a canister according to claim 1,
wherein the charge line which runs downward along outside of the fuel tank is gas-tightly connected to the canister which is annexed to the engine on the side of a head cover of a cylinder after the charge line is fixed by a clamp on a heat insulated side of a heat insulation plate.

3. A multipurpose engine equipped with a canister according to claim 2,
wherein a purge duct line that leads the evaporated fuel desorbed in the canister to an air suction system of the engine runs on an exhaust gas manifold side of the engine;
wherein a joint of the purge duct line is fitted on an end plate of the canister, and the plate is facing to the exhaust gas manifold side;
a joint of an air suction line is fitted on an end plate of the canister, the plate facing to the air suction system side; and
wherein through the joint, clean air via an air cleaner can be sent to the canister.

4. A multipurpose engine equipped with a canister according to claim 3,
wherein clean air flows into the fuel tank through the air suction line, the canister, the charge line, and the rollover valve so as to cancel a negative pressure in case when a pressure inside the fuel tank drops below an ambient pressure.
